(19) United States
(12) Patent Application Publication
(10) Pub. No.: US 2012/0255857 A1
(43) Pub. Date: Oct. 11, 2012

(54) Agriculture Kit

(76) Inventors: Arthur Cheng-Hsin Wu, Foster City, CA (US); Alex Yen-I Wu, Foster City, CA (US); Richard Forrest Wu, Foster City, CA (US); William Timothy Wu, Foster City, CA (US)

(21) Appl. No.: 13/084,517

(22) Filed: Apr. 11, 2011

(51) Int. Cl. C25B 11/04; B09C 1/00; C02F 1/461

(52) U.S. Cl. 204/292

(57) ABSTRACT

Disclosed herein is a method for reducing hardened chemical salts in soil and also for improving water quality in irrigating water. The method comprises an electrolysis system in contact with soil to reduce hardened chemical salts. The system also can reduce pest's activity in water through electrolysis and the release of metal ions. The treated water is used further to loosen soil, inhibit pest and disease outbreak in crop field, and improve productivity.

### FIELD OF INVENTION

This invention is related generally to processes and system for use in the treatment of soil, and pests and diseases control management in agriculture, and more specifically to a method and system for reducing chemical salts formed in soil and reducing the chance of pest and disease outbreak in crop field.

### BACKGROUND OF INVENTION

The present invention is directed to the treatment of crop soil and irrigating water, and in particular to reduce hardened chemical salts accumulated in soil, and suppress pathogens, parasites, and reduce toxic chemicals in irrigating water. Achieving high productivity and at the same time keeping soil sustainable is a challenge subject in agriculture practice. Soil and water, these two topics are always in the mind of field operator to manage them properly.

Chemical fertilizer is commonly used to improve productivity in crop field. Chemical fertilizer is a form of chemical salts that mainly combines nitrogen (N), phosphorus (P), potassium (K), and minerals to provide nutrients for plants. Long-term use of chemical fertilizer results in leftover portions deposited into soil. The electrical charges from leftover fertilizer, pesticides, and other charged particles mix with soil and are bounded together like low-quality cement, so soil is hardened. Through each season more leftover fertilizer adds up in the form of hardened chemical salts, and more soil is hardened. The hardened chemical salts are very slow to dissolve back to water. Hardened chemical salts occupy lower portion of top soil, block plant's roots to grow, reduce air pathways, and decrease water holding capacity in soil. Crop grows on hardened soil has a smaller root size. Smaller root leads to lower productivity.

To reduce chemical salts, prior art teaches the farming practice of applying microbiological or organic fertilizers, so the chemical salts can be gradually decomposed by the introduced microorganisms. This approach can reduce the area of hardened chemical salts and can loosen soil, but the rate of decomposing is slow. Additionally the result is uneven in the crop field.

After harvest, usually crop field stops irrigation to conserve energy cost. But this opens a window opportunity for leftover chemical fertilizer to form hardened chemical salts, to cause crop field holding less water and to harden more soil. Crop with smaller root size grows less. The direct consequence is to require adding more chemical fertilizer in order to maintain productivity.

Furthermore, water quality for irrigation deteriorates due to water resource becomes more and more limited. Irrigating water from upstream contains runoff from an animal farm or other crop fields. It contains high amount of nitrate, nutrients and other chemicals. Upstream lagoon becomes a place to grow algae, larvae, parasites, nematodes, and pathogens. When pests and diseases outbreak happened at upstream, almost certain all the downstream crop fields have various negative impacts.

In the agriculture, commercial and industrial application, there is a need to have an effective method and an efficient system to improve irrigating water quality, reduce hardened chemical salts, and loosen soil. For this reason, there remains substantial room for improvement in the field.

### SUMMARY OF THE INVENTION

The present invention relates to a system having an electron-providing negatively charged electrode and a positively charged electrode arranged vertically, and is capable of loosening soil and reducing the area of hardened chemical salts. Furthermore, the system with and without its outer fixture is used to improve irrigating water quality and for pest and disease suppression in crop field.

It is an object of the present invention to provide a system, which is capable of breaking up chemical salts formed in soil to loosen soil, and the salt compounds can be dissolved back in water and become nutrient for plant again.

It is another object of the present invention to provide a system, which is versatile and suitable for crop field operation. Still further in accordance with a preferred embodiment of the present invention is used to inhibit damaging organisms such as pathogens, algae, and parasites to livestock, crops, humans or land fertility, and reduce toxic chemicals in irrigating water.

These and other objects and advantages of the present invention will become clear to those skilled in the art upon review of the following specification, the accompanying drawings and the appended claims.

### BRIEF DESCRIPTION OF THE DRAWINGS

FIG. 1 is an overall diagrammatical view of an agriculture kit according to the present invention.

FIG. 2 is an overall diagrammatical view of an agriculture kit with its outer housing fixture for improving water quality.

### DETAILED DESCRIPTION OF THE PREFERRED EMBODIMENTS

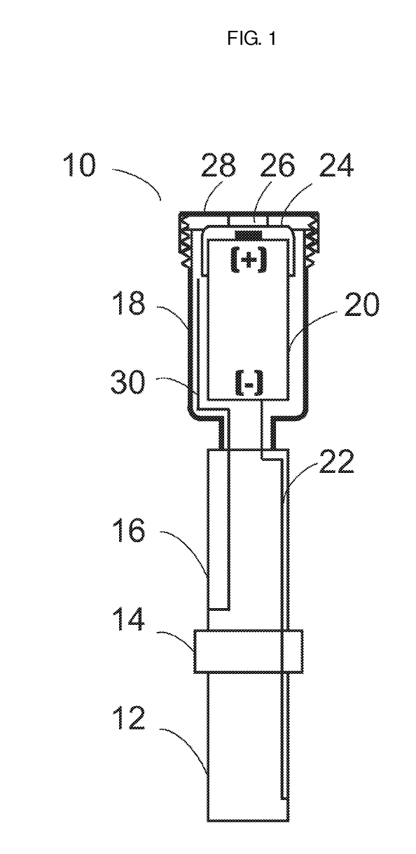

A preferred embodiment of the agriculture kit is illustrated in schematic diagram in FIG. 1 and is referred to by the general reference character 10. In this illustration, it may be seen that the agriculture kit 10 includes the metal tube 12 has one closed end and its other side is connected to the coupling 14. At the other side of coupling 14, it is connected to the metal tube 16. And at the other end of metal tube 16, it is connected to the pipe assembly 18.

Metal tube 12 and metal tube 16 are used for electrolysis and in general are made of copper. Other electrically conducting materials such as silver, gold, platinum and titanium and the likes can be used for specific applications. And the coupling 14 is made of electrically non-conducting material such as PVC plastic, rubber and the likes.

Inside the pipe assembly 18, a battery set 20 is in place. Battery set 20 can be one or more batteries based on commercial availability. This can be a battery with 1.5 volts up to 9 volts for series of batteries or single 9-volts battery. As indicated in FIG. 1, the wire 22 has one end connecting to the negative terminal (−) of battery set 20, and the other end of wire 22 through metal tube 16 and the coupling 14 internally is connected to the inside wall of metal tube 12. At near the positive terminal (+) of battery set 20, a metal cap 24 is in place to attach or detach to the positive terminal (+). The back end of metal cap 24 has an elastic material 26. And the other end of elastic material 26 is attached to the end cap 28, which can be screwed onto the pipe assembly 18.

When end cap 28 is screwed onto the pipe assembly 18, end cap 28 pushes metal cap 24 to attach to the positive terminal (+) of battery set 20. Additionally metal cap 24 contacts to the wire 30 which is located inside wall of pipe assembly 18, and the other end of wire 30 passing through internal pipe assembly 18 is connected to the inside wall of metal tube 16. By controlling the position of end cap 28, the battery set 20 can supply power to metal tube 12 and metal tube 16. Therefore when end cap 28 is properly screwed onto the pipe assembly 18, the battery power from battery set 20 is on and metal tube 12 becomes negatively charged and metal tube 16 becomes positively charged. When end cap 28 is turned loose, the battery power is off.

The field operator can insert the agriculture kit 10 into soil up to the point of lower end of pipe assembly 18, screw end cap 28 properly to turn on its battery power, and spray water to the surrounding soil. In that area if it has cations and anions in soil, positively charged cations move toward the electron-providing negative electrode, which is metal tube 12, whereas negatively charged anions move toward the positively charged electrode, which is metal tube 16.

If the inserted location has chemical salts nearby, the movements of positively charged and negatively charged salt compounds break up the formation of hardened chemical salts. Spray water on that particular location routinely, the soil at that particular location is loosened further. These hardened chemical salts are dissolved in water and become nutrients for plants again.

An advantage of the present invention is the efficiency of reducing hardened chemical salts in soil once identified. The field operator can insert the agriculture kit 10 into a spot, and place agriculture kit 10 at that location for a period of time. The duration of time is based on the soil condition. Different types of soil characters, salt compounds, and the amount of water affect soil electrical conductivity. In general, the reaction time for breaking up hardened chemical salts is in the range of 10 to 30 minutes. After soil is loosened, spray water routinely through that hole can loosen up more chemical salts in its surrounding.

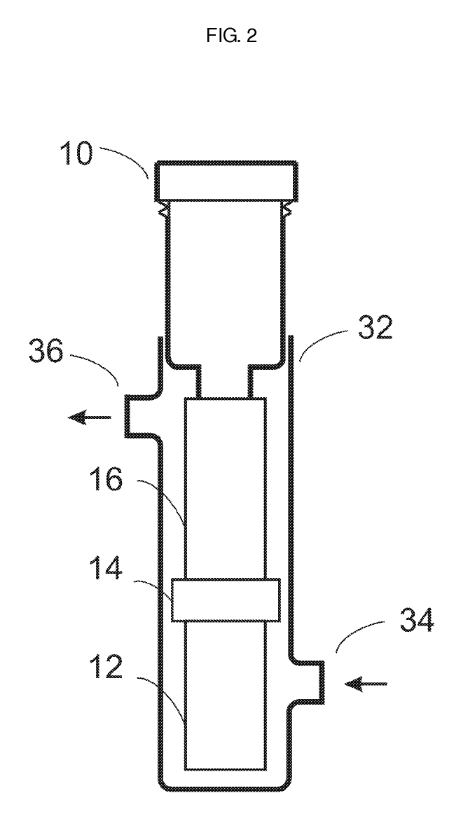

The agriculture kit 10 presented in this invention is also used to improve water quality. As illustrated in FIG. 2, the agriculture kit 10 is placed into a fixture 32. This outer housing fixture 32 has the inlet 34 located at the lower part, and the outlet 36 located at upper part. Water from upstream river, lagoon, well, or reservoir is fed though inlet 34, and is discharged through outlet 36. When sufficient cations and anions presented in water, agriculture kit 10 starts performing electrolysis. The metal 12 releases electrons and the metal 16 releases metal ions.

If the water contains damaging organisms such as algae, lavas, parasites, nematodes, and pathogens, the electrical field generated from agriculture kit 10 and metal ions from metal 16 setting up an environment to harm them, so after treated water discharged from the outlet 36, the damaging organisms are injured to various extents and their further activities are retarded. So these organisms either stop existing prematurely or have much lower activities and negative impacts into crop field.

Irrigating water has various dissolved particles in there, and some of them are energized to become ionized particles through electrolysis. For example, dissolved carbon dioxide could become carbonate, and oxygen could become ozone, etc. These ionized particles in irrigating water can further react with hardened chemical salts in field, and help reduce the area of hardened soil.

Metal tube 16 releases metal ions during electrolysis. If metal tube 16 is made of copper, metal tube 16 releases copper ions. If metal tube 16 is made of combination of copper and silver, metal tube 16 will release copper and silver ions. These ions presented in water can further inhibit pest and disease outbreak in crop field.

Furthermore, if the incoming water contains toxic chemicals such as phenoxyl herbicides, 2,4-D (2,4, dichlorophenoxyacetic acid), and 2,4,5-T (2,4,5 trichlorophenoxyacetic acid), the electrons and the electrical field generated from agriculture kit 10 can break up the phenoxyl herbicides and also to other toxic chemicals presented in water.

Those skilled in the art will readily recognize that numerous other modifications and alterations of the specific structures, dimensions, materials and components may be made without departing from the spirit and scope of the invention. For example, the battery set 20 in agriculture kit 10 can use a rechargeable battery plus a solar panel to supply electrical power. Same methodology discussed above can apply to aquaculture for shrimp and fish farming, and to environmental treatments. Accordingly, the above disclosure is not to be considered as limiting and the appended claims are to be interpreted as encompassing the entire scope of the invention.

### INDUSTRIAL APPLICABILITY

The agriculture kit 10 according to the present invention is adapted to be utilized in a wide variety of industrial, municipal, agriculture, aquaculture applications wherein it is desired to reduce the amount of algae, lavas, parasites, pathogens and toxic chemicals in water, and to loosen soil through breaking up chemical salts. The agriculture kit 10 is adapted particularly for agriculture farming.

Plants such as vegetables, cotton, corn, etc., each one has a specific growing period after seedling. If plants miss that particular growing period, the final productivity for that season will become lower by several percentages. A cost effective method is needed to control the fertilizer cost, to loosen soil, to inhibit pests and diseases in field, and to make crop field sustainable in the long-term.

When it is desired to utilize the invention for improving water quality in irrigation, the field operator can setup the agriculture kit 10 with its outer housing fixture 32 as illustrated in FIG. 2. The agriculture kit 10 has water from river, well, reservoir, or aquifer. The treated water with fewer active algae, larvae, parasites, and pathogens is collected in a pond for irrigation.

The use of water with ionized particles from agriculture kit 10 for irrigation can further reduce hardened chemical salts in the crop field. After regular irrigation, if there is a spot that its soil is still hardened, the field operator can insert the agriculture kit 10 into that particular location to loosen hardened chemical salts. This action also leads to more air pathways into soil, so more ecological activities can be developed. With fewer amount of fertilizer deposited in soil, the field operator can apply fewer amount of fertilizer to begin with, this in term can save more in fertilizer cost.

The diameter ratio between the coupling 14 and the metal tube 16 of agriculture kit 10 affects the range of electrical field. A bigger size coupling 14 can force the electrical field entering more into surrounding. The preferred diameter ratio between the coupling 14 and the metal tube 16 is from 1 to 4.

The use of water with low dose of copper ions or even mixed with silver ions from agriculture kit 10 can further inhibit the potential pest and disease outbreak in crop field. With fewer amount of organisms such as algae, larvae, pesticides, and pathogens entering into crop field, the field operator can extend the interval for pesticide spraying. This in term can save more in overall pesticide cost. In the event there is a disease outbreak in crop field, the field operator can switch back to regular pesticides to control the disease for avoid further spreading.

In light of the many efficiencies and advantages of the agriculture kit 10 of the present invention, it is expected to appeal to a great number of potential users. It is cost effective in operation for reducing algae, larvae, parasites, and pathogens in water, and efficiency to reduce hardened chemical salts in soil. The agriculture kit 10 is versatile and is easy to operate in a crop field. Accordingly it is expected that the agriculture kit 10 according to the present invention will have industrial applicability and commercial utility which are both wide spread and long lasting.

The invention claimed is:

1. An agriculture kit for improving water quality and loosening soil, comprising:
a first metal as negatively charged electrode for providing electrons;
a second metal as positively charged electrode for providing metal ions;
wherein the first metal is located at a lower position and the second metal is located at an upper location of the kit for insertion into the soil and into the water.

2. The agriculture kit of claim 1, further comprising a coupling made of electrically non-conducting material, wherein the coupling is located between the first metal and the second metal.

3. The agriculture kit of claim 1, wherein the first metal and the second metal contain copper.

4. A water quality improvement kit, comprising:
a first metal for releasing electrons;
a second metal for releasing metal ions;
wherein the first metal is positioned lower than the second metal; and
wherein water flows through the first metal for receiving the electrons and the second metal for receiving the metal ions.

5. The water quality improvement kit of claim 4, wherein the first metal and the second metal contain copper.

6. A disease suppression stick for water and for soil, comprising:
a first metal tube for releasing electrons;
a second metal tube for releasing metal ions;
a coupling made of electrically non-conducting material;
wherein the first metal tube, the coupling, and the second metal tube are placed in sequence to form the stick.

7. The disease suppression stick of claim 6, wherein diameter ratio between the coupling and the second metal tube is from 1 to 4.

8. The disease suppression stick of claim 6, wherein the first metal tube and the second metal tube contain copper.
